(19) United States
(12) Patent Application Publication
(10) Pub. No.: US 2013/0026863 A1
(43) Pub. Date: Jan. 31, 2013

(54) METHOD OF MANUFACTURING ANISOTROPIC BONDED MAGNET AND MOTOR USING THE SAME MAGNET

(71) Applicant: Hiroki Asai, Hyogo (JP)

(72) Inventor: Hiroki Asai, Hyogo (JP)

(73) Assignee: PANASONIC CORPORATION, Kadoma-shi, Osaka (JP)

(21) Appl. No.: 13/638,761

(22) PCT Filed: Jan. 31, 2012
(86) PCT No.: PCT/JP2012/000588

§ 371 Date: Oct. 1, 2012

(30) Foreign Application Priority Data
Feb. 3, 2011 (JP) 2011-021332

(51) Int. Cl. B29C 41/02; H02K 1/27

(52) U.S. Cl. 310/44; 264/429

(57) ABSTRACT

A method of manufacturing anisotropic bonded magnets includes four steps. The first step fills a compressing metal mold with a compound chiefly made of flaky anisotropic magnetic particles. The second step forms a compression molded substance by molding the compound in the metal mold within an orientation magnetic field. The third step couples the compressing metal mold to a molding metal mold together. The fourth step moves the compression molded substance from the compressing metal mold to the molding metal mold, and then deforms and molds the compression molded substance into a given shape. This method allows controlling the anisotropy of the anisotropic bonded magnet.

### TECHNICAL FIELD

The present invention relates to a method of manufacturing an anisotropic bonded magnet and a motor using the same magnet.

### BACKGROUND ART

The anisotropic magnet generally has a property of uniaxial anisotropy relative to an isotropic magnet, so that stronger magnetic characteristics can be expected in the anisotropic magnet. However, when an anisotropic magnet having uniaxial anisotropy is used in a motor, cogging torque should be reduced for improving the motor performance. When the anisotropic magnet is molded, it is thus important to control a direction of orientation of the anisotropic magnet in order to improve the motor performance.

For instance, when a compression molded substance of the anisotropic magnet is produced by compression molding with its direction of orientation controlled, a unidirectional orientation magnetic field is formed for anisotropic magnetic particles of the compression molded substance to be oriented therein.

When a direction of orientation of the magnetic particles needs to be changed, ferromagnetic substance of high magnetic permeability is embedded at a part of non-magnetic metal mold for changing a uniform magnetic field into any direction. The direction of orientation of the magnetic particles can be thus changed.

A manufacturing method of controlling a direction of the orientation of the anisotropic magnet has been proposed recently. This method hardens a magnet oriented along a uniaxial direction, and then the magnet undergoes a mechanical deformation, e.g. stretching or deformation for changing the direction of orientation to any direction (for instance, refer to patent literatures 1 and 2).

In the case of forming a compression molded substance in the orientation magnetic field, there are two major methods, i.e. a parallel magnetic field molding method in which a direction of the orientation magnetic field agrees with a compressing direction, and an orthogonal magnetic field molding method in which a direction of the orientation magnetic field intersects the compressing direction at right angles. The orientation magnetic field direction regularly employs the orthogonal magnetic field molding method in which a lateral directional orientation magnetic field is used; however, another orthogonal magnetic field molding method, in which an orthogonal directional orientation magnetic field is used, is also disclosed in, e.g. patent literature 3.

The following method of controlling the direction of orientation of the anisotropic magnet is not yet disclosed. The method is carried out this way: First, compress a melted compound formed of flaky magnetic particles such that the compound can be stretched along the in-plane direction. At this time, apply the orientation magnetic field along a direction that allows the thickness direction of the flaky magnetic particles to tend to turn to an orthogonal direction. Then the flaky magnetic particles are further compressed along the orthogonal direction for forming the compression molded substance. This method is not disclosed yet.

An anisotropic bonded magnet, of which orientation is controlled in an any direction by a conventional mechanical deformation, is a composite formed of NdFeB in aggregated particle state and SmFeN in fine particle state. This composite undergoes the compression molding method, in which molding pressure of 50 MPa is applied, to be the compression molded substance. The molding pressure of 50 MPa is a rather low pressure, so that the compression molded substance can be mechanically deformed after the molding and hardening.

However, the anisotropic NdFeB magnetic particles formed through HDDR (Hydrogenation Decomposition Desorption Recombination) process includes flaky anisotropic NdFeB magnetic particles besides NdFeB in aggregated particle state. Use of flaky anisotropic NdFeB magnetic particles for producing the composite magnetic substance formed of NdFeB and SmFeN thus encounters the following problem:

The foregoing composite magnetic substance in a given shape encounters rather lower compressive properties when it is molded comparing with the anisotropic magnet that is produced by molding a compound formed of anisotropic magnet of anisotropic NdFeB magnetic particles in aggregated particle state. This compound formed of anisotropic magnet includes magnetic particles and resin material mixed together at a conventional composition rate that allows maintaining high magnetic characteristics, and those materials undergo multiple steps of mixing, kneading, and classifying.

The use of anisotropic NdFeB magnetic particles including the flaky ones for producing the anisotropic magnet needs a molding pressure as high as 100-300 MPa in order to obtain high magnetic characteristics. The anisotropic NdFeB magnetic particles per se are flaky, so that mechanical deformation properties adversely decrease after the molding and hardening.
Patent Literature 1: WO2009/142005
Patent Literature 2: WO2006/022101
Patent Literature 3: Unexamined Japanese Patent Application Publication No. H07-173505

### DISCLOSURE OF THE INVENTION

A method of manufacturing anisotropic bonded magnet includes the steps of:
a first step of filling a compressing metal mold with compound chiefly made of flaky anisotropic magnetic particles; (the metal mold is used for producing a compression substance)
a second step of molding the compound filled in the metal mold into a compression molded substance within an orientation magnetic field;
a third step of coupling the compressing metal mold with molding metal mold; and
a fourth step of moving the compression molded substance into the molding metal mold, and deforming the substance into a given shape for molding.

The foregoing method allows the compression molded substance, of which orientation is done during the molding, to change its direction of the orientation into a given direction through a mechanical deformation without lowering the deformation properties. As a result, an anisotropic bonded magnet in a given shape, e.g. arc shape, can be formed with ease.

The foregoing method also allows the use of an anisotropic magnet material, having low deformation properties and containing flaky magnetic particles, to produce an anisotropic bonded magnet in a given shape with a high accuracy.

A motor of the present invention includes a rotor equipped with the foregoing anisotropic bonded magnets of which direction of the orientation can be controlled in any direction, and this rotor achieves the motor of high performance.

### BRIEF DESCRIPTION OF THE DRAWINGS

FIG. 1A is a perspective view of an arc-shaped anisotropic bonded magnet corresponding to one of the poles of a rotor in accordance with a first embodiment of the present invention.

FIG. 1B is a plan view of an example of a rotor formed of the arc-shaped anisotropic bonded magnets in accordance with the first embodiment.

FIG. 2 is a flowchart for describing a method of manufacturing the anisotropic bonded magnet in accordance with the first embodiment of the present invention.

FIG. 3A shows a first step of the manufacturing method of the anisotropic bonded magnet in accordance with the first embodiment of the present invention.

FIG. 3B shows a second step of the manufacturing method of the anisotropic bonded magnet in accordance with the first embodiment of the present invention.

FIG. 4 shows a third step of the manufacturing method of the anisotropic bonded magnet in accordance with the first embodiment of the present invention.

FIG. 5A shows a fourth step of the manufacturing method of the anisotropic bonded magnet in accordance with the first embodiment of the present invention.

FIG. 5B shows the fourth step of the manufacturing method of the anisotropic bonded magnet in accordance with the first embodiment of the present invention.

FIG. 5C shows the fourth step of the manufacturing method of the anisotropic bonded magnet in accordance with the first embodiment of the present invention.

FIG. 5D shows the fourth step of the manufacturing method of the anisotropic bonded magnet in accordance with the first embodiment of the present invention.

FIG. 6A shows a first step of the manufacturing method of the anisotropic bonded magnet in accordance with a second embodiment of the present invention.

FIG. 6B shows the first step of the manufacturing method of the anisotropic bonded magnet in accordance with the second embodiment of the present invention.

FIG. 6C shows step 2A of the manufacturing method of the anisotropic bonded magnet in accordance with the second embodiment of the present invention.

FIG. 7 shows step 2B of the manufacturing method of the anisotropic bonded magnet in accordance with the second embodiment of the present invention.

FIG. 8 shows a third step of the manufacturing method of the anisotropic bonded magnet in accordance with the second embodiment of the present invention.

FIG. 9A shows a fourth step of the manufacturing method of the anisotropic bonded magnet in accordance with the second embodiment of the present invention.

FIG. 9B shows the fourth step of the manufacturing method of the anisotropic bonded magnet in accordance with the second embodiment of the present invention.

FIG. 9C shows the fourth step of the manufacturing method of the anisotropic bonded magnet in accordance with the second embodiment of the present invention.

FIG. 9D shows the fourth step of the manufacturing method of the anisotropic bonded magnet in accordance with the second embodiment of the present invention.

### DETAILED DESCRIPTION OF THE PREFERRED EMBODIMENT

A method of manufacturing an anisotropic bonded magnet and a motor equipped with the same magnet are demonstrated hereinafter with reference to the accompanying drawings. The present invention is not limited by those embodiments.

### Embodiment 1

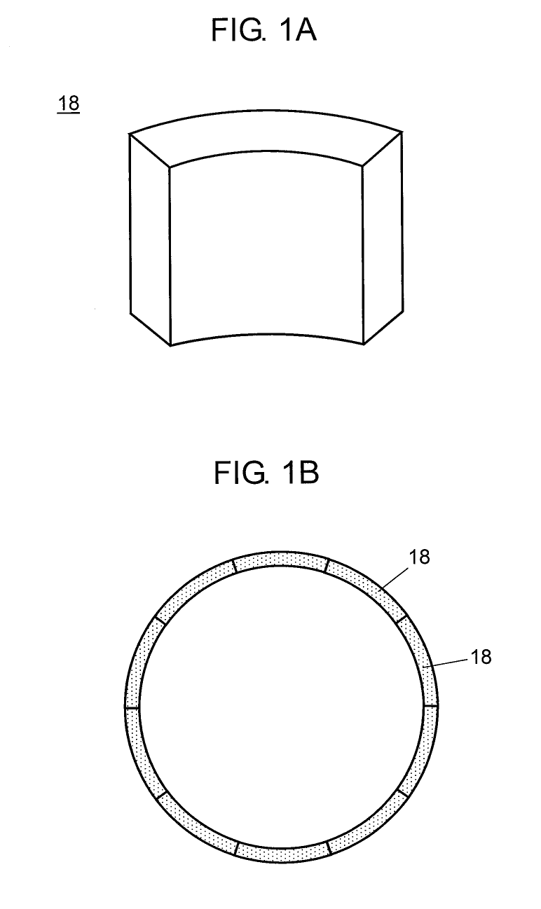

The anisotropic bonded magnet manufactured by the method in accordance with the first embodiment of the present invention is demonstrated hereinafter with reference to FIG. 1A and 1B. The anisotropic magnet is an arc-shaped and corresponds to one of the poles of a rotor. This embodiment also refers to this rotor.

FIG. 1A is a perspective view of an arc-shaped anisotropic bonded magnet corresponding to one of the poles of the rotor in accordance with the first embodiment. FIG. 1B is a plan view of an example of the rotor formed of arc-shaped anisotropic bonded magnets in accordance with the first embodiment. In this embodiment an arc-shaped anisotropic bonded magnet corresponding to one pole out of 10 poles of the rotor is described.

As shown in FIG. 1A anisotropic bonded magnet 18 in accordance with this embodiment is chiefly formed of NdFeB-based magnetic particles and SmFeN-based magnetic particles, and these magnetic particles are anisotropically modified such that they have an axis along which uniaxial magnetization is done easily. Magnet 18 forms an arc-shape and corresponds to one of 10 poles of the rotor. 10 magnets of this arc-shaped anisotropic bonded magnet are bonded to a rotor core made of silicon steel lamination, whereby the rotor shown in FIG. 1B is formed. This rotor is assembled with a stator to form a motor.

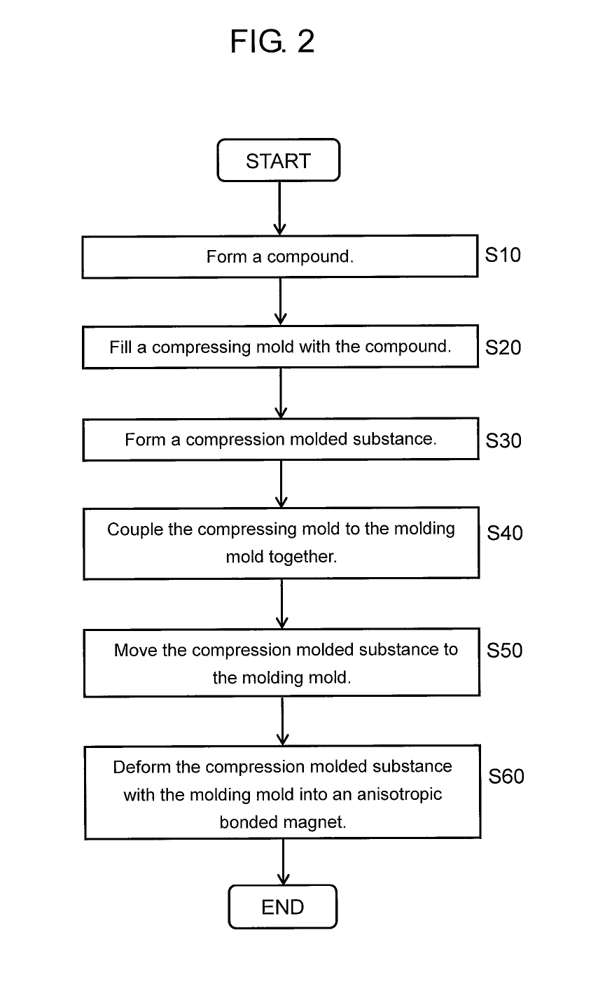

A method of manufacturing the anisotropic bonded magnet in accordance with the first embodiment is demonstrated hereinafter with reference to FIG. 2-FIG. 5D.

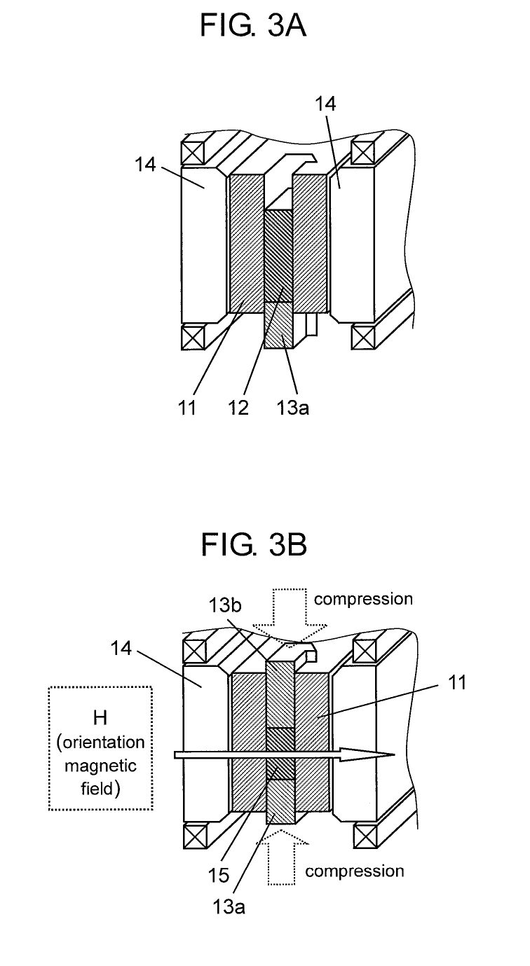

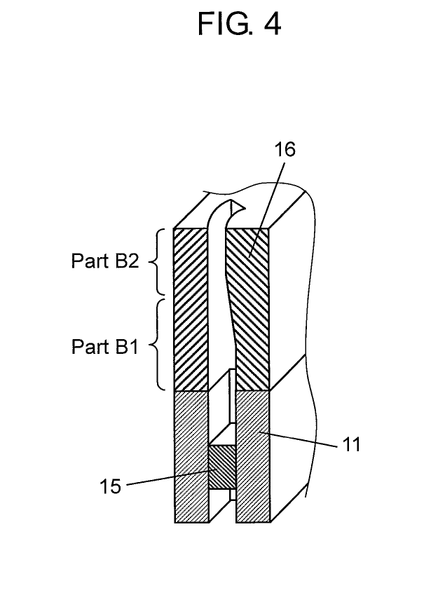

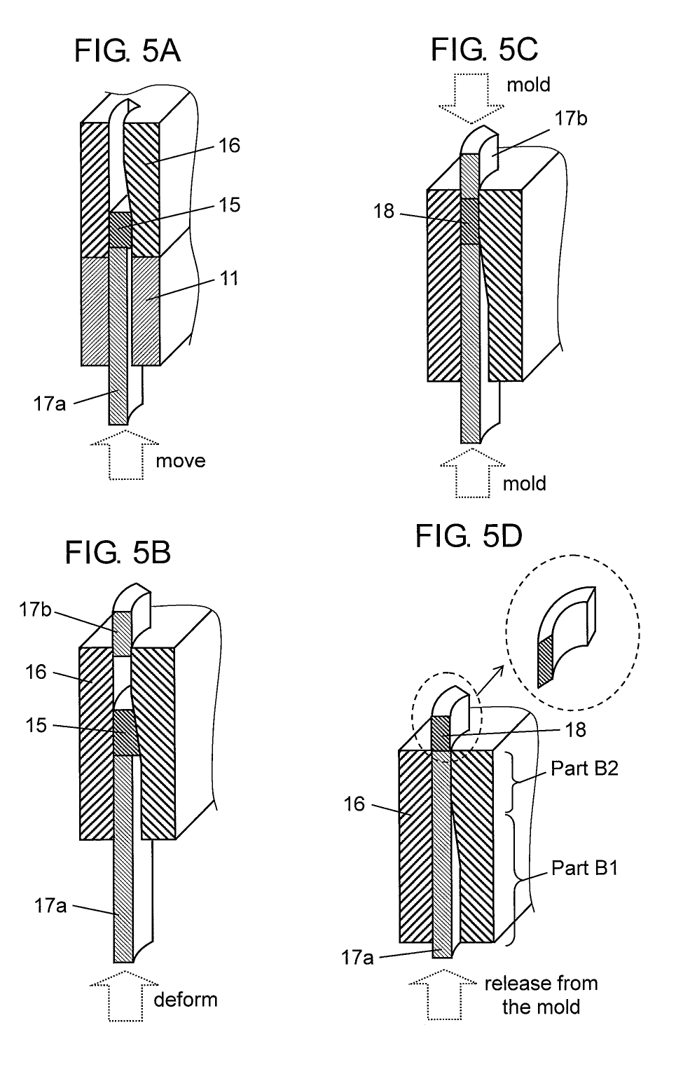

FIG. 2 is a flowchart describing the method of manufacturing the anisotropic bonded magnet in accordance with the first embodiment. FIG. 3A depicts a first step of the manufacturing method, FIG. 3B depicts a second step of the method, FIG. 4 depicts a third step of the method, and FIG. 5A-5D depict a fourth step of the method.

As shown in FIG. 2, firstly a compound is formed by following way (step S10):

Knead well NdFeB magnetic particles having undergone anisotropy with novolak epoxy resin dissolved in acetone by using a kneader. This epoxy resin is thermoset resin softening at e.g. 80° C. Then vaporize the acetone, whereby a film of epoxy resin is formed on the surfaces of NdFeB magnetic particles.

In a similar way, knead SmFeN fine particles with novolak epoxy resin dissolved in acetone by using a kneader. This epoxy resin is thermoset resin softening at e.g. 80° C. Then vaporize the acetone, whereby a film of epoxy resin is formed on the surfaces of SmFeN fine particles.

The NdFeB magnetic particles and the SmFeN fine particles, both of the particles are covered with the epoxy resin, are mixed with polyamide resin and lubricant in order to give the particles flexibility and adhesiveness by using a mixer. As a result, a mixture is produced. The mixing ratio of NdFeB magnetic particles vs. SmFeN fine particles is, e.g. 3:2. The content of the epoxy resin is 1.1 wt %, and the content of the polyamide resin and the lubricant is 1.7 wt % respectively.

The foregoing mixing ratio and the contents are not limited to the values discussed above, and not to mention, they can be changed in response to the characteristics required.

The foregoing mixture is input continuously into spaces between rollers heated, this rollers work as a kneading apparatus, whereby kneaded substance is produced. Polyamide resin is softened during this kneading, so that this resin is kneaded into the kneaded substance. At this time the rollers are not necessarily heated to a melting point of the polyamide resin, and the rollers are heated up to, e.g. 140° C. before the kneading. An extruder can be used as a kneading apparatus instead of the rollers.

The foregoing kneaded substance formed of magnetic particles and polyamide resin is cooled down to an ambient temperature, and then the substance is crushed into granular powders of which grain size is 500 μm or less. At this time imidazole-based hardening agent in fine particle state is added to and mixed with the granular powders for producing the compound. The hardening agent starts hardening at 170° C.

Next as shown in FIG. 2 and FIG. 3A show, the compression molded substance is formed by using the foregoing compound through first step and second step discussed below: First, prepare a compressing metal mold 11 (hereinafter simply referred to as mold A11) shaped like a square and having a cavity penetrating through. In the first step, fill the cavity of mold A11 with compound 12 (step S20).

Place mold A11 filled with compound 12 between orientation magnets 14 of a magnetic field generator that includes orientation magnets 14 producing orientation magnetic field, and then generate the orientation magnetic field between magnets 14 in order to orient the magnetic particles of compound 12 along a given direction. Compound 12 is supported by lower punch 13a which is to be used in the step described later.

Next as shown in FIG. 3B, apply the orientation magnetic field to the magnetic particles of compound 12 filled in metal mold A11, and then compress and mold compound 12 through the cavity of mold A11 by suing lower punch 13a and upper punch 13b. This is the second step. As a result, rectangular-shaped compression molded substance 15, in which the direction of orientation of magnetic particles of compound 12 is aligned in a certain direction, is formed (step S30). At this time, the compression molding is carried out in this condition: temperature of mold A11=160° C., molding pressure=150 MPa, orientation magnetic field strength=1.3 MA/m, molding time=30 seconds. Magnetic field orientation molding is done in, e.g. orthogonal magnetic field. Setting the temperature of mold A11 at 160° C. allows the magnetic particles of compound 12 in non-oriented state to be oriented along a desirable direction with ease.

After compression molded substance 15 is formed, apply an AC magnetic field in the foregoing state, and reduce the strength of the magnetic field gradually, i.e. mold A11 is demagnetized by this demagnetizing method. This demagnetization is done for preventing the magnetic particles from attaching to the metal mold in the later steps.

Next as shown in FIG. 2, couple mold A11 with molding metal mold 16 (hereinafter simply referred to as mold B16) in the third step described below (step S40). First, as shown in FIG. 3B, remove lower punch 13a and upper punch 13b from mold A11, and retain rectangular compression molded substance 15 within mold A11. Next, as shown in FIG. 4, couple mold A11 with mold B16 with compression molded substance 15 retained in mold A11. At this time, both of mold A11 and mold B16 are heated to 160° C. The temperature of mold B16 is important for deforming the compressed compression molded substance 15, and the temperature gives influence to the shape of anisotropic bonded magnet having undergone the deformation. In other words, when mold B 16 is heated to as high as 200° C., direction of the orientation is disturbed during the deformation of the compression molded substance, and a desirable orientation cannot be achieved. The magnetic particles of the compression molded substance are affected by the heat, and the magnetic characteristics are adversely lowered. To the contrary, when mold B16 is heated only to as low as 60° C., this temperature is lower than the softening point of the epoxy resin forming compression molded substance 15, so that substance 15 cannot be deformed, and the anisotropic bonded magnet having a controlled orientation cannot be produced. Considering the stable temperature of mold A11 and mold B16, it is preferable to set both of the molds at the same temperature.

Mold 16B has a cavity of which opening on the coupling side to mold A11 forms a rectangular shape, and the opposite opening forms an arc shape, so that the cavity changes it shape, e.g. from a rectangle to an arc. This mold is thus different in shape, namely, as shown in FIG. 4, mold B16, which is used for producing an arc shaped anisotropic bonded magnet, is formed of two parts, i.e. part B1 and part B2. Part B1 of mold B16 is used for deforming the rectangular compression molded substance into an arc-shape. Part B2 of mold B16 is used for compressing and molding arc-shaped compression molded substance 15 into the final anisotropic bonded magnet in a given arc-shape. Mold B16 can be formed of different molds having part B1 and part B2 respectively.

Next as shown in FIG. 2, the foregoing compression molded substance 15 is moved from mold A11 to mold B16 in the fourth step discussed below (step S50). Compression molded substance 15 is mechanically deformed into a given shape by mold B16, whereby the anisotropic bonded magnet can be molded (step S60).

First as shown in FIG. 5A, compression molded substance 15 staying in mold A11 is pushed and moved by molding punch Ba17a into mold B16. In this case, since mold 11A and mold B16 are coupled together, compression molded substance 15 needs not to be released from mold A11, so that it is not needed to worry about dimensional changes caused by a spring-back regularly involved during the mold release. Molding punch Ba17a preferably has at least a face, which is brought into contact with compression molded substance 15, in an approx. the same shape (including the same shape) as the arc-shaped opening of mold B16.

Next as shown in FIG. 5B, compression molded substance 15 moved into the cavity of mold B16 is further pushed forward in part B1 by molding punch Ba17a, so that substance 15 is sequentially deformed along the cavity that changes in shape from a rectangle to an arc, and is finally molded into an arc shape.

Next as shown in FIG. 5C, compression molded substance 15 pushed by molding punch Ba17a is compressed and molded in part B2 of mold B16 by molding punch Bb17b inserted into the arc-shaped opening of mold B16, and substance 15 is thus molded into a given shape with given dimensions. For instance anisotropic bonded magnet 18 having dimensions of height=13.0 mm, thickness=1.5 mm can be thus formed. At this time, considering the movement of substance 15 from mold A11 to mold B16 and a pressure applied to substance 15 along the height direction during the deformation in mold B16, the height of compression molded substance 15 formed in mold A11 is preferably set at 13.5 mm, in other words, the height is set greater by 5% or less than that of the final anisotropic bonded magnet.

Next as shown in FIG. 5D, remove molding punch Bb17b from mold B16, and push anisotropic bonded magnet 18 with molding punch Ba17a out from mold B16, whereby arc-shaped anisotropic bonded magnet 18 can be obtained. The anisotropic bonded magnet 18 corresponding to one of the poles of a rotor can be thus produced as a magnet for the rotor of motor.

Next, produce anisotropic bonded magnets 18 in a quantity equal to the number of poles of a motor, and bond them to a rotor core for completing the rotor. At this time an inner curvature of the arc-shaped anisotropic bonded magnet should be designed to agree with the curvature of the rotor-core face where the magnets are to be bonded. In the case of joining each of the arc-shaped anisotropic bonded magnets to form a ring, a change in dimensions before and after the joining should be considered.

This embodiment allows the compression molded substance having undergone the orientation during the compression and molding to avoid a degradation in deformation properties caused by the spring- back, and to undergo mechanical deformation sequentially. According to the manufacturing method in accordance with this embodiment, the direction of orientation can be changed in a given direction, and an anisotropic bonded magnet shaped in a given shape, e.g. arc-shape, can be formed with ease. As a result, the anisotropic bonded magnet in a given shape with high accuracy can be produced although the magnet material containing flaky magnetic particles and having low deformation properties is used.

This embodiment also proves that the rotor equipped with the anisotropic bonded magnets, of which direction of orientation can be controlled in any direction, can achieve a motor of high performance with ease.

### Embodiment 2

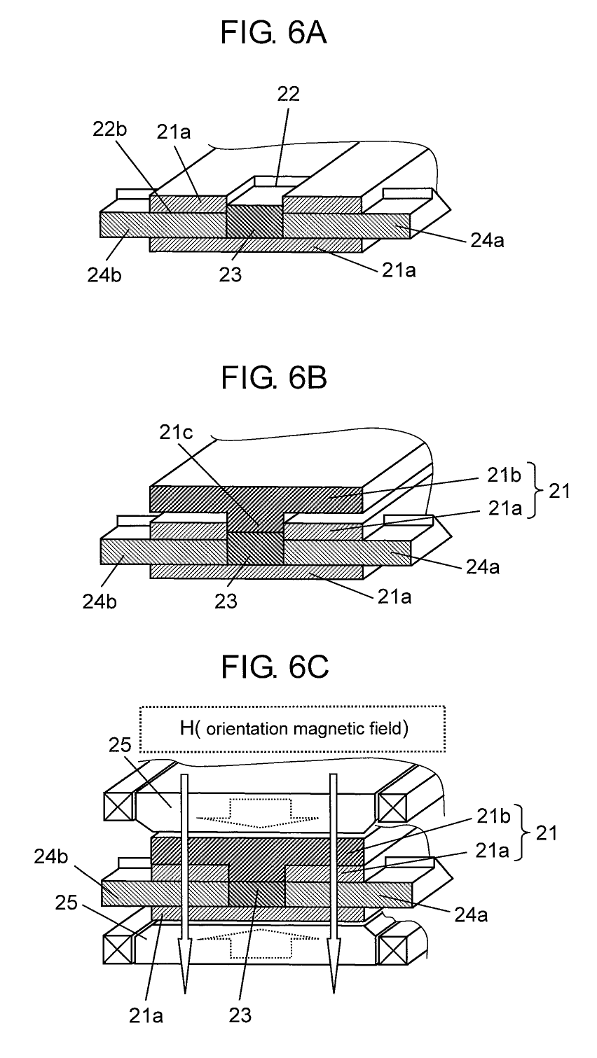

A method of manufacturing anisotropic bonded magnets in accordance with the second embodiment of the present invention is demonstrated hereinafter with reference to FIG. 6A-FIG. 9D. The shape of the anisotropic bonded magnet and the motor equipped with the rotor formed of these anisotropic bonded magnets are the same as those described in the first embodiment, so that the descriptions thereof are omitted here.

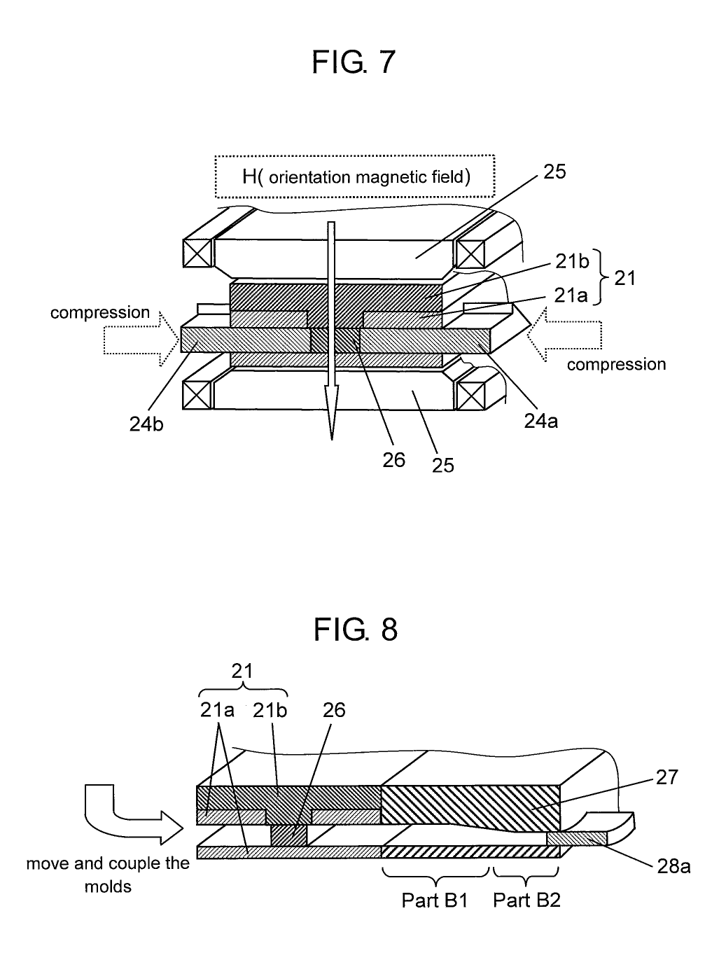

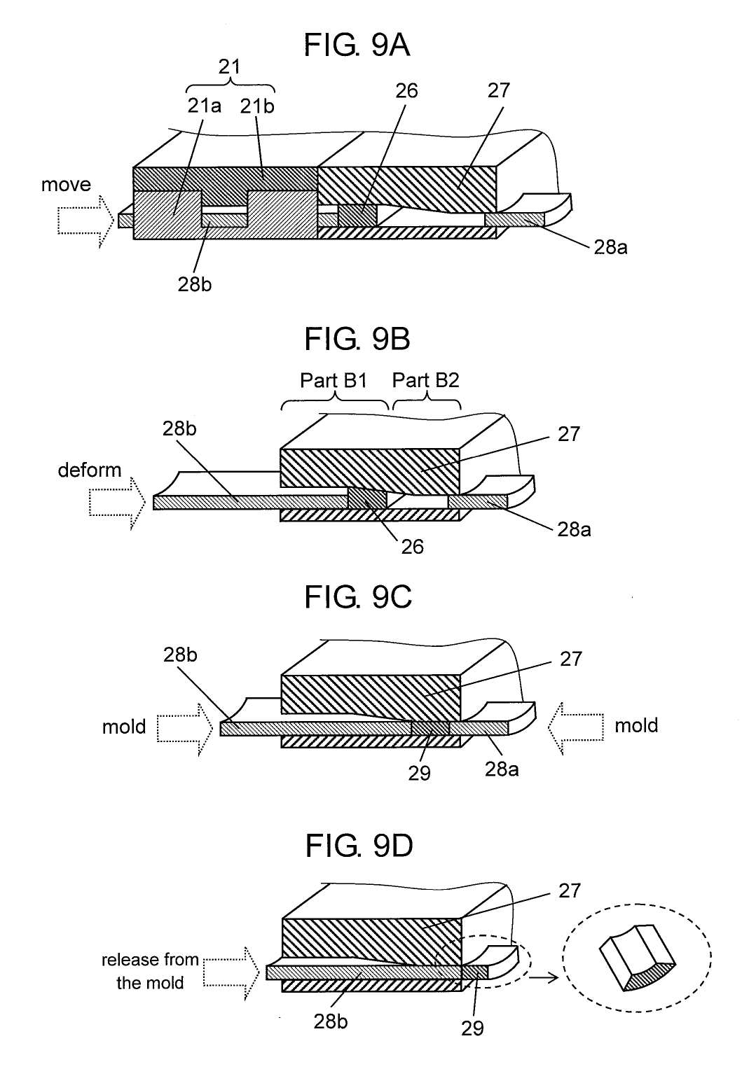

FIG. 6A and FIG. 6B illustrate the first step of the manufacturing method of the anisotropic bonded magnet in accordance with the second embodiment. FIG. 6C illustrates step 2A of the method, and FIG. 7 illustrates step 2B of the method. FIG. 8 illustrates the third step of the method, and FIG. 9A-FIG. 9D illustrate the fourth step of the method.

As shown in FIG. 6A and FIG. 6B, compressing metal mold 21 (hereinafter simply referred to as mold A21) differs from mold A11 used in the first embodiment in the following point: Mold A21 is formed of first member 21a having groove 22, and second member 21b having projection 21c that fits in groove 22. Because of this structure, a method of manufacturing a compression molded substance differs from that of the first embodiment, and a compressing direction differs from an applying direction of orientation magnetic field. Other basic structural elements and steps of the manufacturing method remain unchanged from those of the first embodiment, so that the descriptions thereof are omitted here.

An example of the manufacturing method of the anisotropic bonded magnets in accordance with the second embodiment is demonstrated hereinafter with reference to FIG. 6A-FIG. 9D, and the flowchart shown in FIG. 2.

First, as shown in FIG. 2, form a compound following the method described below (step S10) as it is done in embodiment 1.

NdFeB magnetic particles having undergone anisotropy, SmFeN magnetic particles, novolac epoxy resin and polyamide as binder, and resin chiefly made of lubricant are mixed together following the steps done in embodiment 1, whereby the mixture is produced. At this time, the mixing ratio of NdFeB magnet material vs. SmFeN magnet material is, e.g. 4:1, and the amount of the resin to be mixed with the foregoing magnet materials is kept unchanged from that used in embodiment 1.

The mixture thus produced is kneaded on the rollers heated as it is done in embodiment 1, and then cooled. The cooled mixture is made into granular powder of which size is not greater than 500 μm. At this time, imidazole-based hardening agent in fine particle state is added to and mixed with the granular powder, whereby the compound is produced. The hardening agent starts hardening at 170° C.

Next as shown in FIG. 2 and FIG. 6A, the foregoing compound undergoes the first and second steps described below to form a compression molded substance. The second step of this embodiment includes two steps, i.e. step 2A and step 2B.

First as shown in FIG. 6A, in the first step, fill the foregoing compound 23 into groove 22 recessed in first member 21a of mold A21 (step S20). At this time, first member 21a includes through-hole 22b in lateral direction besides groove 22 formed in vertical direction, and compressing punches Aa24a and Ab24b are inserted in through-hole 22b from both sides toward groove 22. The thickness of these punches will regulate a thickness of the compression molded substance in a vertical direction (the vertical direction in FIG. 6A). This substance is produced by compressing the compound 23.

Next as shown in FIG. 6B, second member 21b is laid on first member 21a such that projection 21c of second member 21b can fit in groove 22 of first member 21a. The height of projection 21c is equal to a value resulting from a deduction of the thickness of compressing punch Aa24a or Ab24b from the depth of groove 22, or the height is set slightly greater than this value. This structure allows compression molded substance 26, formed by compressing the compound 23, to move laterally with ease.

Next as shown in FIG. 6C, in step 2A, hold horizontally an opening of groove 22 of first member 21a of mold A21 filled with compound 23, and place mold A21 between orientation magnets 25 of a magnetic field generator that generates magnetic field for orientation, and magnets 25 are disposed vertically in the generator.

Then fit projection 21c of second member 21b into groove 22 of first member 21a of mold A21, thereby compressing the magnetic particles of compound 23. At this time, generate the magnetic field for orientation between orientation magnets 25 along the same direction as the compressing direction for orientating the magnetic particles of compound 23.

Next in step 2B, as shown in FIG. 7, further compress the compound 23 with compressing punches Aa24a and Ab24b along the direction vertical relative to the applying direction of the orientation magnetic field, whereby compression molded substance 26 is molded (step S30). This compression molding is done in the condition of temperature of mold A21=160° C., molding pressure=150 MPa, orientation magnetic field strength=1.3 MA/m, molding time=30 seconds. This condition allows forming the compression molded substance 26 with dimensions of e.g. thickness=1.5 mm, height=13.5 mm. This is similar to those of embodiment 1.

After the formation of substance 26, apply an AC magnetic field in the foregoing condition for weakening the magnetic field strength gradually, in other words, mold 21A is demagnetized, thereby preventing the magnetic particles from attaching to mold A21.

Next as shown in FIG. 2 and FIG. 8, compressing mold 21 is coupled to molding mold 27 (hereinafter simply referred to as mold B27) in the third step described below (step S40).

First, as shown in FIG. 8, remove compressing punches Aa24a and Ab24b from mold A21, and place mold A21 and mold B27 side by side on the same plane with the rectangular (for instance) compression molded substance 26 retained in mold A21 before coupling the two molds together. Both the molds are heated to 160° C.

Mold B27 includes a cavity of which opening is shaped like a rectangle, and this rectangular opening is located on the coupling side to mold A21. Another opening of the cavity opposite to the rectangular one is shaped like an arc, so that mold B27 changes its shape, e.g. from the rectangular shape to the arc shape as embodiment 1. As shown in FIG. 8, mold B27 to be used for forming an arc-shaped anisotropic bonded magnet is formed of two parts, e.g. part B1 and part B2. Part B1 deforms the rectangular compression molded substance 26 into an arc shape. Part B2 of mold B27 compresses and molds the arc-shaped substance 26 into a final shape, i.e. a given arc-shaped anisotropic bonded magnet. Mold B27 having part B1 and part B2 can be formed of different molds each of which has part B1 and part B2 respectively.

Next as shown in FIG. 2, and FIG. 9A-FIG. 9D, in the fourth step described below, move the foregoing compression molded substance 26 from mold A21 to mold B27 (step S50), then deform substance 26 with mold B27 into a given shape, whereby the anisotropic bonded magnet is molded (step S60).

First as shown in FIG. 9A, push the compression molded substance 26 staying in mold A21 out and move into mold B27 with molding punch Bb28b. In this case since mold A21 is coupled to mold B27, substance 26 is not needed to release from mold A21, so that it is not needed to worry about dimensional changes caused by a spring back regularly involved during the mold release.

Next as shown in FIG. 9B, push forward the compression molded substance 26, which has been moved in the cavity of mold B27, in part B1 of mold B27 with molding punch Ba28a. This push-forward allows deforming substance 26 along the cavity of which shape changes from a rectangle to an arc in mold B27, so that substance 26 is molded into an arc shape.

Next as shown in FIG. 9C, further push forward the substance 26 with molding punch Bb28b into part B2 of mold B27, and in part B2, substance 26 is compressed and molded with molding punches Ba28a and Bb28b inserted into arc-shaped opening, whereby substance 26 is molded into anisotropic bonded magnet 29 in a given shape with given dimensions. For instance magnet 29 having a height of 13.0 mm and thickness of 1.5 mm can be obtained. At this time, considering the movement of substance 26 from mold A21 to mold B27 and a pressure applied to substance 26 along the height direction during the deformation in mold B27, the height of compression molded substance 26 formed in mold A21 is preferably set at 13.5 mm, in other words, the height is set greater by 5% or less than that of the final anisotropic bonded magnet. The temperature of the metal mold and a relation between the mold and the compression molded substance during the deformation of the substance with mold B27 remain unchanged from those used in embodiment 1, so that the descriptions thereof are omitted here.

Next as shown in FIG. 9D, remove molding punch Ba28a from mold B27 and push anisotropic bonded magnet 29 out from mold B27 with punch Bb28b, whereby arc-shaped anisotropic bonded magnet 29 is obtained. The anisotropic bonded magnet 29 corresponding to one of the poles of a rotor of a motor is thus produced.

Next, produce anisotropic bonded magnets 29 in a quantity equal to the number of poles of a motor, and bond them to a rotor core for completing the rotor. At this time an inner curvature of the arc-shaped anisotropic bonded magnet should be designed to agree with the curvature of the rotor-core face where the magnets are to be bonded. In the case of joining each of the arc-shaped anisotropic bonded magnets to form a ring, a change in dimensions before and after the joining should be considered.

As discussed above, this embodiment 2 produces an advantage similar to that of embodiment 1, and the compound is compressed in two steps, i.e. step 2A and step 2B so that the compound can be filled into the mold at a higher density, and the compound containing the flaky magnetic particles can be oriented more efficiently in the magnetic field. The reason is described below.

In general, flaky magnetic particles have undergone anisotropy such that they have an easy magnetizing axis in the thickness direction of the flakes. In the case of filling the cavity of groove 22 in metal mold A21 with the compound, the groove depth (filled depth) needs, e.g. approx. three times of the size of the compression molded substance because the bulk density of the compound should be taken into consideration. For instance assume that the compound has a bulk density of 2.3 g/cm³ and a final anisotropic bonded magnet has a density of 5.9 g/cm³, then the depth of groove 22 needs 2.6 times or more than the height (reference value) of groove 22. It is thus preferable to change the depth of groove depending on the bulk density of the compound and the density of final anisotropic bonded magnet.

The compound is filled into the cavity while the metal mold is heated to 160° C., so that the compound tends to attach to the wall of the groove in the metal mold. The groove wall thus prevents the compound from being filled smoothly, and the cavity sometimes cannot be filled uniformly with the compound.

The compound is filled into the cavity such that the compound is dropped into the cavity. As a result, the flaky magnetic particles tend to be filled such that the thickness direction of the flake (easy magnetizing axis direction) is directed along the opening direction at the upper side of the mold. The longitudinal axis of the flaky magnetic particles is thus directed laterally when they are filled. During the compression molding in the orientation magnetic field after the filling, the orientation magnetic field is applied along orthogonal direction relative to the filling direction for orientating the compound. As a result, the magnetic particles resist rotating along the direction of the orientation magnetic field, so that the compression molded substance cannot be uniformly oriented.

To overcome this problem in this second embodiment, the filling direction of the compound agrees with the applying direction of orientation magnetic field in step 2A so that the orientating properties of the flaky magnetic particles can be improved. Then in step 2B, the filling density of the compression molded substance, i.e. compressing again the compound, can be increased along an orthogonal direction relative to the applying direction of the orientation magnetic field. This mechanism allows producing the compression molded substance at a high density and more efficiently while both the orientating properties and the filling properties are kept high.

According to this second embodiment, a rotor equipped with the foregoing anisotropic bonded magnets, which are filled at high density and of which orientation can be controlled in any direction, can achieve with ease a motor of higher performance.

In the embodiments discussed previously, NdFeB-based magnetic particles having an easy-magnetizing axis along uni-axial direction and SmFeN-based magnetic particles are used as materials for the compound; however, the present invention is not limited to these materials, for instance, SmCo-based rare earth magnet of magnetic single domain particle type can be used.

In the embodiments discussed previously, metal molds A and B are kept at 160° C. during the compression and molding; however, the present invention is not limited to this temperature, for instance, mold A is kept at a temperature different from that of mold B during the compression and molding. In other words, the temperature can be set at any value as far as the temperature will not lower drastically the flexibility of the compression molded substance during the movement from mold A to mold B, and the temperature should be not higher than the hardening point of the hardening agent contained in the compound.

### INDUSTRIAL APPLICABILITY

The present invention is useful for the anisotropic bonded magnet containing flaky magnetic particles that need highly dense filling and high orientating properties. The present invention is also useful in the technical field of a rotor equipped with the foregoing magnets, and a motor including the same rotor.

### Description of Reference Marks

11, 21 Mold A (compressing metal mold)

12, 23 Compound

13a Lower Punch

13b Upper Punch

14, 25 Orientation Magnet

15, 26 Compression Molded Substance

16, 27 Mold B (molding metal mold)

17a, 28a Molding Punch Ba

17b, 28b Molding Punch Bb

18, 29 Anisotropic Bonded Magnet

21a First Member

21b Second Member

21c Projection

22 Groove

22b Through-hole

24a Compressing Punch Aa

24b Compressing Punch Ab

1. A method of manufacturing an anisotropic bonded magnet, the method comprising:
a first step of filling a compressing metal mold with a compound chiefly made of flaky anisotropic magnetic particles;
a second step of forming a compression molded substance by molding the compound filled in the compressing metal mold within an orientation magnetic field;
a third step of coupling the compressing metal mold with a molding metal mold; and
a fourth step of moving the compression molded substance from the compressing metal mold to the molding metal mold, and deforming and molding the substance into a given shape.

2. The method of claim 1, wherein in the second step, the compression molded substance is molded in the orientation magnetic field which is applied along an orthogonal direction relative to a compressing direction.

3. The method of claim 1, wherein the compressing metal mold includes at least a first member having a groove to be filled with the compound, and a second member having a projection which fits in the groove for compressing the compound,
wherein the second step includes step 2A and step 2B, and in step 2A the orientation magnetic field is applied while the compound filled in the groove of the first member is compressed with the projection along a fitting direction of the second member into the first member, and in step 2B the compression molded substance is molded with the orientation magnetic field applied while compressing the substance in a direction orthogonal to the fitting direction of the second member into the first member.

4. The method of claim 3, wherein the orientation magnetic field is applied along the fitting direction of the second member into the first member.

5. A motor including a rotor equipped with the anisotropic bonded magnet manufactured by the method as defined in any one of claim 1 through claim 1.

6. A motor including a rotor equipped with the anisotropic bonded magnet manufactured by the method as defined in claim 2.

7. A motor including a rotor equipped with the anisotropic bonded magnet manufactured by the method as defined in claim 3.

8. A motor including a rotor equipped with the anisotropic bonded magnet manufactured by the method as defined in claim 4.
